(19) United States
(12) Patent Application Publication
(10) Pub. No.: US 2007/0073989 A1
(43) Pub. Date: Mar. 29, 2007

(54) METHOD AND APPARATUS FOR EFFICIENT DATA STORAGE AND MANAGEMENT

(75) Inventors: Sanjeev K. Sharma, Pottstown, PA (US); Sudhir B. Pattar, Mount Laurel, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/468,197

(22) Filed: Aug. 29, 2006

Related U.S. Application Data
(60) Provisional application No. 60/712,803, filed on Aug. 31, 2005.

(51) Int. Cl. G06F 13/00

(52) U.S. Cl. 711/165

(57) ABSTRACT

A method and apparatus for efficient data storage and management in order to reduce battery consumption in a mobile device are disclosed. Two data stores, an unorganized store and an organized store, are provided in the mobile device. The unorganized store stores a data in as-it-arrives basis. The organized store stores data in a way that is more efficient for data search and retrieval. A controller controls the unorganized store and the organized store such that new data is stored in the unorganized store while the mobile device is battery powered and moved to the organized store while the mobile device is powered by an external power source. The data is retrieved from the organized store once the data is moved to the organized store.

### CROSS REFERENCE TO RELATED APPLICATION

This application claims the benefit of U.S. Provisional Application No. 60/712,803 filed Aug. 31, 2005, which is incorporated by reference as if fully set forth.

### FIELD OF INVENTION

The present invention is related to a data storage management in a mobile device. More particularly, the present invention is related to a method and apparatus for efficient data storage and management in order to reduce battery consumption in a mobile device.

### BACKGROUND

With the advances in memory and storage technology, the available capacity for data storage on the mobile devices is going to be nearly infinite. The user will need to search and use large amounts of information quite often. Inefficient searches over a vast storage will drain the limited battery power of the mobile devices. The usage of the information itself can also affect the battery consumption, (e.g., mp3 playback).

In prior art, data is stored on a storage device on an “as-it-arrives” basis. Though there is some limited organization of data in terms of folders and subfolders, the storage mechanism is not necessarily efficient for searches. Different parts of a single file may be physically stored on different tracks or sectors of a hard disk. Two files grouped under the same folder may be stored quite apart on the hard disk, possibly depending on the time gap between their storage. Different file types of similar content have different characteristics. For example, both mp3 and wav files belong to the music category. Some metadata about the bit rate, artist, copyrights, and the like may be found in the initial part of the files. However, the arrangement of this metadata in the mp3 file is different from that in a wav file.

In the prior art, the storage of data is almost completely dependent on its time of arrival. The files may be fragmented, (i.e., stored on distant physical locations). This slows down the search. There is no uniform metadata across different file types even though they fall in the same content category (like music or pictures). This requires different search methods for different file types of similar content category. In addition, due to limited memory, files are stored in a compressed form. They need to be decompressed on the fly during use. This results in higher processing load during the file use. The inefficient searches and extensive run time processing cause more power drain of the battery of the mobile devices.

### SUMMARY

The present invention is related to a method and apparatus for efficient data storage and management in order to reduce battery consumption in a mobile device. Two data stores, an unorganized store and an organized store, are provided in the mobile device. The unorganized store stores a data in as-it-arrives basis. The organized store stores data in a way that is more efficient for data search and retrieval. A controller controls the unorganized store and the organized store such that new data is stored in the unorganized store while the mobile device is battery powered and moved to the organized store while the mobile device is powered by an external power source. The data is retrieved from the organized store once the data is moved to the organized store.

### BRIEF DESCRIPTION OF THE DRAWINGS

FIG. 1 is a block diagram of an apparatus for data storage and management in accordance with the present invention.

FIG. 2 shows an exemplary organized store including a plurality of substores in accordance with the present invention.

FIG. 3 is a flow diagram of a process for storing data in accordance with the present invention.

FIG. 4 is a flow diagram of a process for retrieving data in accordance with the present invention.

### DETAILED DESCRIPTION OF THE PREFERRED EMBODIMENTS

When referred to hereafter, the terminology “mobile device” includes but is not limited to a user equipment (UE), a wireless transmit/receive unit (WTRU), a mobile station, a fixed or mobile subscriber unit, a pager, a notebook computer, a palmtop computer, a personal data assistant (PDA), or any other type of portable devices.

The features of the present invention may be incorporated into an integrated circuit (IC) or be configured in a circuit comprising a multitude of interconnecting components.

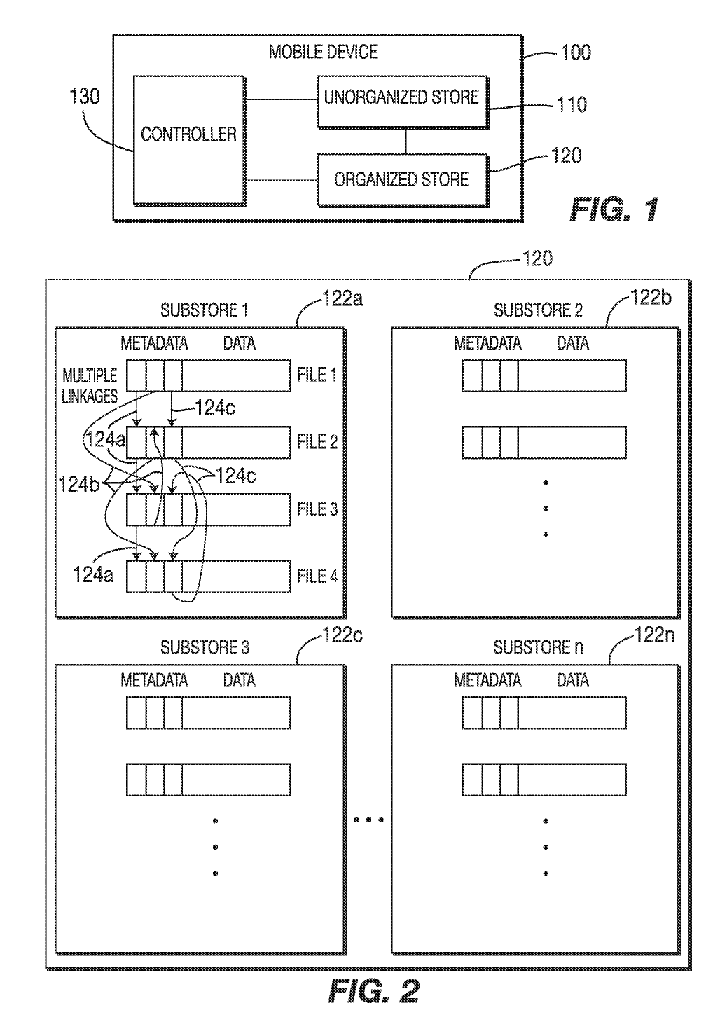

FIG. 1 is a block diagram of a mobile device 100 for data storage and management in accordance with the present invention. The apparatus 100 includes an unorganized store 110, an organized store 120 and a controller. The unorganized store 110 is similar to conventional data storage devices. The controller 130 controls the unorganized store 110 and the organized store 120 to store and retrieve data, such that all data is stored in the unorganized store 110 while the mobile device is battery powered, and the data stored in the unorganized store 110 is moved to the organized store 120 while the mobile device 100 is powered by an external power source, such as being charged with an AC adapter. When data is queried, the organized store 120 is first accessed, and the unorganized store 110 is accessed only if the data is not found in the organized store 120. The data is stored in the organized store 120 in a way that is optimized for data search and retrieval. Therefore, battery power consumption of the mobile device is reduced for searching and retrieving the data from the organized store 120.

When the mobile device 100 is battery powered, once the data is moved to the organized store 120, the mobile device 100 does not consume its battery for data analysis, movement, decompression, metadata insertion, or the like. When the mobile device 100 is on the external power, the mobile device 100 switches to a higher operating voltage and frequency to perform very fast computations for data analysis, data movement from the unorganized store 110 to the organized store 120, decompression of the compressed data, metadata generation and insertion, or the like.

The data is first stored in the unorganized store 110 in an as-it-arrives basis. If the data is compressed, the data is stored in the unorganized store 110 in a compressed format. The unorganized store 110 is needed for backward compatibility with all file types, efficient usage of the transmission media, (i.e., data flows in compressed format to conserve the bandwidth), efficient usage of the battery power, (i.e., compressed data is stored in less time), and random nature of data arrival which means that different content types may arrive at different times.

The organized store 120 may be organized into a plurality of substores. FIG. 2 shows an exemplary organized store including a plurality of substores 122a-122n in accordance with the present invention. The controller 130 analyzes the content of the data and stores the data in one of the substores 122a-122n based on the content of the data. For example, all music files are stored in a substore for music, (e.g., substore 122a), and all image files are stored in a substore for image files, (e.g., substore 122b). The content type is not decided simply by looking at the file extension but by analyzing some part of the data. For example, a music file whose extension is modified as .doc is still recognized as a .wav file. This integrity check is needed to maintain sanity.

The substores may be user independent. In other words, the substores do not follow the Windows'“C:\Documents and Settings\User\My Documents\My Music” paradigm. It follows user defined paradigm, such as “C:\Music” paradigm. This results in efficient search of shared files.

The controller 130 attaches metadata to the data before storing the data in the organized store 120. The metadata is search oriented, resulting in efficient searches. The metadata may be generated when the content of the data is analyzed. For example, a picture file may contain a date and time imprint. The data and time imprint is extracted when the data is analyzed and converted into metadata. The format of the metadata is uniform across all the files in the same substore because of the similar content nature of the substore. By making the metadata uniform, only one search method is needed for all the files within the substore.

Sharing rights to the data between users may be defined by the metadata. The metadata may have a “public/private” flag. If the flag is set to “private”, the data may have an “owner” associated with it and only the owner may access the data. If the flag is set to “public”, the data may be accessed by anyone.

All data in the organized store 120 is stored in a decompressed format. If the mobile device 100 originally received the data in a compressed format, the data is stored in the unorganized store 110 in a compressed format and the controller 130 decompresses the data while moving the data to the organized store 120. For example, mp3 files are converted into wav format before storing them in the organized store 120. This minimizes the run-time power consumption while the mobile device 100 is battery powered because no run-time data conversion is needed.

All parts of a file are stored at the same physical location of the organized store 120, (i.e., there is no fragmentation of the file). This makes the run-time access of the file smooth without having to jump across tracks.

Keyword dependent linked lists may be provided based on the metadata. For example, all Jazz music files may form one linked list. At the same time all the music by artist John Lennon may form another parallel linked list. Also all the music files released in 2005 may form another linked list. Thus, the same file is accessible by different paths, depending on the keyword.

The linked lists of the files in the substore are illustrated in FIG. 2. The linked list includes a plurality of pointers for pointing to a next and a previous file in the linked list. For example, in substore 122a, four (4) files, file 1-file 4, are currently stored. The four files are linked together by three (3) linked lists 124a-124c based on three different keywords. The first linked list 124a includes pointers for linking file 1 to file 2, linking file 2 to file 3 and linking file 3 to file 4. The second linked list 124b includes pointers for linking file 1 to file 3, linking file 3 to file 2 and linking file 2 to file 4. The third linked list 124c includes pointers for linking file 1 to file 2, linking file 2 to file 4 and linking file 4 to file 3.

For example, the linked lists may be formed by sorting the files in an alphabetical order on the basis of filenames, creation timestamps, access timestamps, or the like, and inserting pointers to previous and next files as the metadata. If there is no keyword itself, the file may still be searched efficiently because it is already sorted alphabetically. This is useful if no special keyword or property can be found within the file or data to associate it with a keyword or property-based search method. This linking is preferred from the run-time sorting provided by the conventional file-based operating systems because the run-time processing consumes battery power.

The linked lists and uniform metadata make searching efficient by any keyword.

When a file is deleted, it is unnecessary to move the rest of the data since the mobile device 100 has sufficient storage. Only the access flags in the metadata need to be modified to make the file inaccessible and the previous and next pointers for the linked list need to be updated. This ensures that there is no disk fragmentation.

Certain characteristics applicable to a folder in the unorganized store 110 may be retained for the files while they are being moved to the organized store 120. For example, the unorganized store may include a folder for storing encrypted data. In such case, the organized store may include a special substore for storing the encrypted data. However, actual encryption may not be applied to reduce the run time processing for decryption.

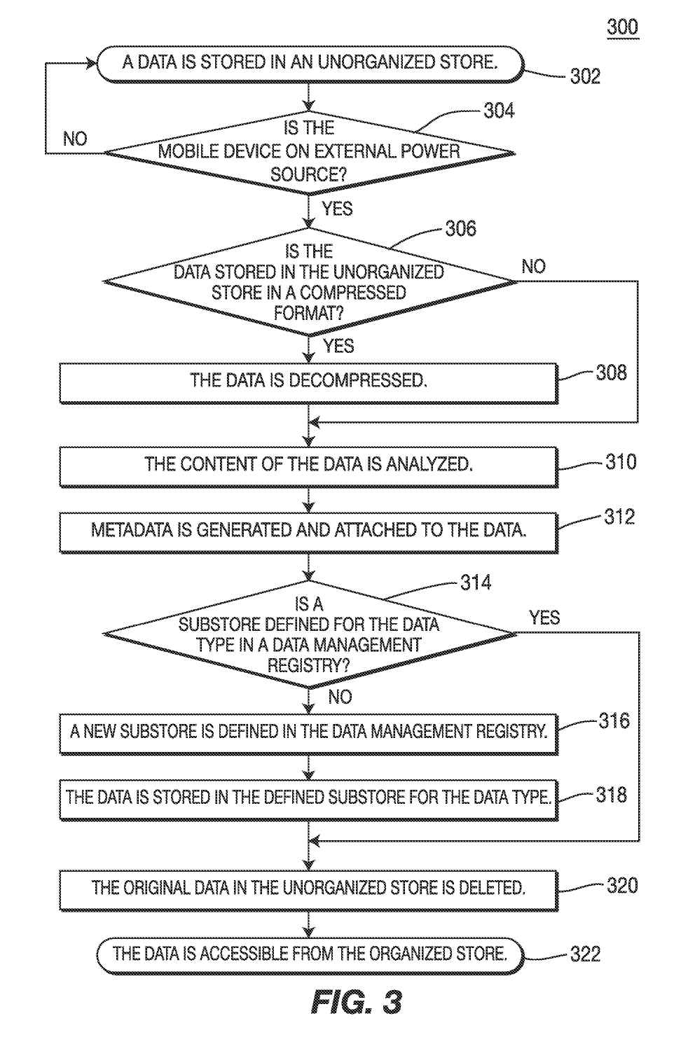

FIG. 3 is a flow diagram of a process 300 for storing data in accordance with the present invention. The mobile device 100 is currently battery powered and data is stored in an unorganized store 110 (step 302). The mobile device 100 monitors whether the mobile device 100 is on external power source (step 304). If the mobile device 100 is not on the external power source, the process 300 returns to step 302. If it is determined at step 304 that the mobile device 100 is on the external power source, the mobile device 100 initiates data movement operation, (steps 306-320), in accordance with the present invention. The mobile device determines whether the data stored in the unorganized store 110 is in a compressed format (step 306). If the data is compressed, the data is decompressed (step 308). After decompression, or if it is determined at step 306 that the data is not compressed, the contents of the decompressed data is analyzed (step 310). After analyzing the content of the data, metadata is generated and attached to the data (step 312).

It is determined whether a substore is defined for the data type in a data management registry (step 314). If there is no substore for the data type, a new substore is defined in the data management registry (step 316). The data is then stored in the defined substore for the data type (step 318). The original data in the unorganized store 110 is then deleted (step 320) and the data is accessible from the organized store (step 322).

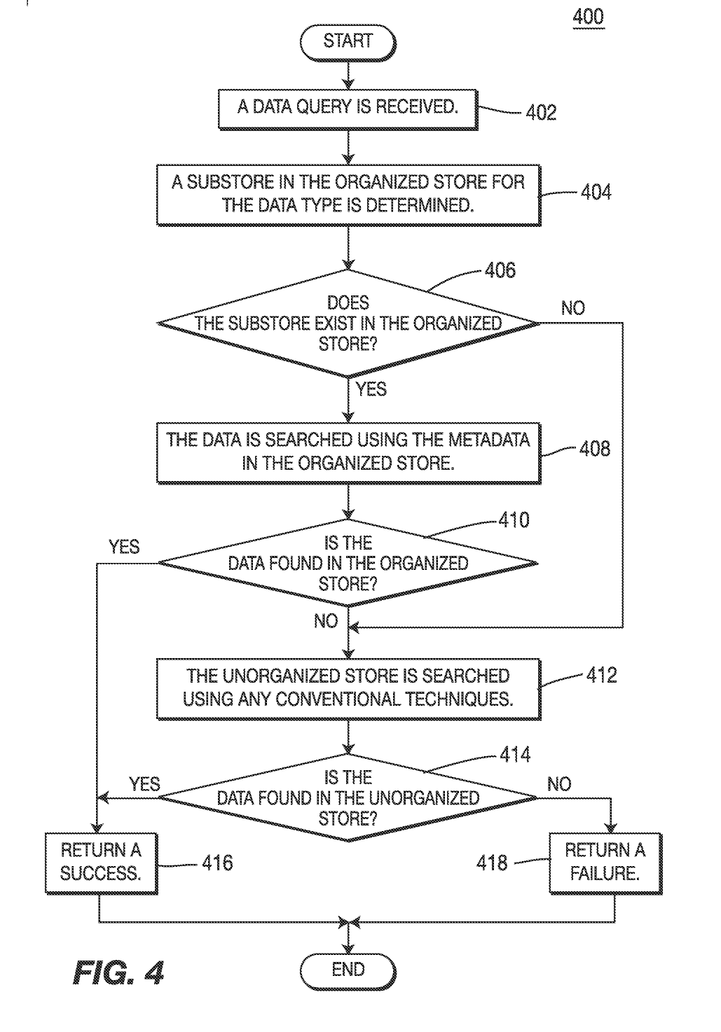

FIG. 4 is a flow diagram of a process 400 for retrieving data in accordance with the present invention. Upon receipt of a data query at step 402, the organized store 120 is first accessed. A substore in the organized store 120 for the data type is determined (step 404). It is determined whether the substore exists in the organized store 120 (step 406). If the substore exists in the organized store 120, the data is searched using the metadata in the organized store 120 (step 408). It is determined whether the data is found in the organized store 120 (step 410). If the data is found in the organized store 120, the process 400 returns a success (step 416). If the data is not found in the organized store 120, or it is determined at step 406 that the substore for the data type does not exist in the organized store 120, the unorganized store 110 is searched using any conventional techniques (step 412). It is determined whether the data is found in the unorganized store 110 (step 414). If the data is found in the unorganized store 110, the process 400 returns a success (step 416). If the data is not found in the unorganized store 110, the process 400 returns a failure (step 418).

Since the organized store 120 is always searched first, the searches would be faster than the conventional mechanisms. Moreover, since the data in the organized store is decompressed and unfragmented, no run-time processing is needed, which results in battery power conservation.

The data retrieval scheme of the present invention may provide an abstraction function to make the storage transparent to applications. For example, if an application expects certain file in some specific folders, (e.g., a system folder in Windows), the controller 130 provides that lookup by translating the lookup request into substore-keyword list-access-rights-etc. combination.

Soft hyperlinks may be generated based on the keyword based linked lists, (i.e., the metadata attached to the stored files). This is more efficient than the conventional hyper text markup language (HTML) that uses hard hyperlinks because the hard hyperlinks do not work well if the data is moved. Examples of the soft hyperlinks are “Music\John Lennon\1972” or “Most Recently Used Documents.”

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for efficient data storage and management in a mobile device, the method comprising:
providing an unorganized store and an organized store;
storing data in the unorganized store when the mobile device is battery powered; and
moving the data stored in the unorganized store to the organized store during a period when the mobile device is powered by an external power source, the organized store storing the data in an efficient way for data search and retrieval, whereby battery power consumption of the mobile device is reduced.

2. The method of claim 1 wherein the data is stored in the unorganized store in an as-it-arrives basis.

3. The method of claim 1 wherein the data is stored in a compressed format in the unorganized store.

4. The method of claim 3 wherein the data is stored in a decompressed format in the organized store.

5. The method of claim 1 wherein the organized store is organized by a plurality of substores.

6. The method of claim 5 wherein the substores are user independent.

7. The method of claim 5 further comprising:
analyzing content of the data before storing the data in the organized store, whereby the data is stored in one of the substores based on the content of the data.

8. The method of claim 5 wherein a metadata is attached to the data based on the content of the data before storing the data in the organized store.

9. The method of claim 8 wherein a sharing right of the data is included in the metadata.

10. The method of claim 8 wherein a metadata format is uniform in the same substore.

11. The method of claim 8 wherein the metadata provides at least one linked list comprising pointers for linking data stored in the organized store in accordance with a key word.

12. The method of claim 8 wherein when data is deleted from the organized store, only an access flag in the metadata for the data is modified to mark the data inaccessible and pointers in the linked list are updated accordingly.

13. The method of claim 8 wherein the linked lists are formed in an alphabetical order.

14. The method of claim 1 further comprising:
receiving a query for a data;
determining whether the queried data is stored in the organized store;
retrieving the queried data from the organized store if the queried data is found in the organized store; and
retrieving the queried data from the unorganized store if the queried data is not found in the organized store.

15. The method of claim 14 further comprising:
determining a substore for the queried data;
if the substore is found in a data management registry, retrieving the queried data in the substore; and
if the substore is not found in the data management registry, retrieving the queried data from the unorganized store.

16. The method of claim 1 wherein the data is stored in the organized store without fragmentation.

17. The method of claim 1 wherein the organized store includes an encrypted folder for storing encrypted data.

18. A mobile device for efficient data storage and management, the mobile device comprising:
an unorganized store for storing data;
an organized store for storing data in a way that is more efficient for data search and data retrieval; and
a controller for controlling data storage and retrieval such that data is stored in the unorganized store while the mobile device is battery powered and the data stored in the unorganized store is moved to the organized store while the mobile device is powered by an external power source.

19. The mobile device of claim 18 wherein the data is stored in the unorganized store in an as-it-arrives basis.

20. The mobile device of claim 18 wherein the data is stored in a compressed format in the unorganized store.

21. The mobile device of claim 20 wherein the data is stored in a decompressed format in the organized store.

22. The mobile device of claim 18 wherein the organized store is organized by a plurality of substores.

23. The mobile device of claim 22 wherein the substores are user independent.

24. The mobile device of claim 22 wherein the controller analyzes content of the data before storing the data in the organized store, whereby the data is stored in one of the substores based on the content of the data.

25. The mobile device of claim 22 wherein the controller attaches a metadata to the data based on the content of the data before storing the data in the organized store.

26. The mobile device of claim 25 wherein a sharing right of the data is included in the metadata.

27. The mobile device of claim 25 wherein a metadata format is uniform in the same substore.

28. The mobile device of claim 25 wherein the metadata provides at least one linked list comprising pointers for linking data stored in the organized store in accordance with a key word.

29. The mobile device of claim 28 wherein the linked lists are formed in an alphabetical order.

30. The mobile device of claim 28 wherein the controller provides a soft hyperlink based on the linked list.

31. The mobile device of claim 25 wherein when data is deleted from the organized store, the controller modifies an access flag in the metadata for the data to mark the data inaccessible and updates pointers in the linked list accordingly.

32. The mobile device of claim 18 wherein the controller retrieves queried data from the organized store if the queried data is found in the organized store and retrieves the queried data from the unorganized store if the queried data is not found in the organized store.

33. The mobile device of claim 32 wherein the controller retrieves the queried data in the substore if a substore for the queried data is found in a data management registry and retrieves the queried data from the unorganized store if the substore for the queried data is not found in the data management registry.

34. The mobile device of claim 18 wherein the data is stored in the organized store without fragmentation.

35. The mobile device of claim 18 wherein the organized store includes an encrypted folder for storing encrypted data.

36. The mobile device of claim 18 wherein the controller provides an abstraction function to make the stores transparent to an application.
